(19) United States
(12) Patent Application Publication
(10) Pub. No.: US 2019/0024358 A1
(43) Pub. Date: Jan. 24, 2019

(54) SURFACE WATER DRAINAGE SYSTEM

(71) Applicant: Aco Severin Ahlmann GmbH & Co., Kommanditgesellschaft, Büdelsdorf (DE)

(72) Inventors: Arne Meincke, Osdorf (DE); Ralf Ihrig, Frankfurt (DE)

(21) Appl. No.: 16/070,993

(22) PCT Filed: Jan. 20, 2017
(86) PCT No.: PCT/EP2017/051157

§ 371 Date: Jul. 18, 2018

(30) Foreign Application Priority Data
Jan. 25, 2016 (DE) 10 2016 101 251.3

(51) Int. Cl. E03F 3/04; E01C 11/22; E03F 5/10; F16L 41/02

(52) U.S. Cl. CPC E03F 3/046; E01C 11/223; E01C 2201/205; F16L 41/023; E03F 5/102

(57) ABSTRACT

Surface water drainage Systems are known, comprising a water drainage body which is elongated by individual elements that can be placed next to one another, and which can be installed in the ground. The individual elements (1-6) comprise an inlet section which is arranged in an upper region of the individual elements (1-6) in such a way that water can flow into the inlet section. A first pipe section (20) is provided, arranged below the inlet section and communicating with same via transition Systems. According to the invention, in order to increase the drainage power, at least one further second pipe section (30), communicating with the first pipe section (20), is to be provided below or next to the first pipe section (20), wherein all the pipe sections (20, 30) can be sealingly connected to corresponding pipe sections (20, 30) of further individual elements (1-6).

The invention relates to a surface water drainage system according to the preamble of claim 1.

Scaled surfaces such as roads, lots, or the like require drainage. This is generally accomplished by open channels; i.e., channel systems, which are covered by gratings.

In order to achieve adequate drainage power during heavy rainfall events, use is made of drainage channels having drainage cross sections that increase in the downstream direction (generally known as cascades). The installation of these cascade systems is very laborious and costly, as drainage channels with different drainage cross sections (i.e., increasing component height with constant nominal width) have to be combined with one another. This results in higher construction costs and planning costs.

Monolithic drainage systems, which comprise both an upper inlet section and upper first pipe sections hydraulically connected to the inlet section, already exist.

Owing to the design of their drain cross sections, the drainage channels described reach the limits of drainage power during heavy rainfall events. The water is no longer completely drained away from the surface. This can cause accidents and must therefore be avoided.

The invention is based on the object of demonstrating a surface water drainage system of the aforementioned type with which greater drainage capacity can be ensured for similar effort and expense. Moreover, the dimensions, in particular the width, of the surface water drainage system should not increase excessively.

This object is achieved by a surface water drainage system according to claim 1.

In particular, this object is achieved by a surface water drainage system comprising a water drainage body, which is elongated by individual elements that can be placed next to one another and which can be installed in the ground, said individual elements comprising:
an inlet section, which is arranged in an upper region of the individual elements in such a way that water can flow into said inlet section,
at least one first upper pipe section arranged below the inlet section and communicating with the same via transition systems, wherein at least one further second pipe section communicating with the first upper pipe section is provided below and/or next to the first pipe section, wherein all pipe sections can be sealingly connected to corresponding pipe sections of further individual elements.

An advantage of this arrangement of a plurality of pipes lies in the fact that with heavy rainfall events, when the inlet section and the pipe sections are filled there will be a hydrostatic effect, by which the drainage capacity is determined in accordance with the concept of communicating vessels and thus in accordance with the rules of closed pipe hydraulics. The drainage capacity of the channel will thus be increased significantly for nearly the same cross section. This effect can be increased further and will commence early if additional pipe sections are arranged below the second pipe section. The increase in drainage capacity results namely from the increasing hydrostatic pressure. The increase in the hydrostatic pressure essentially corresponds to the distance of the lowermost pipe center to the water level of the overhead inlet sections times the square root of 2. A considerable increase in drainage capacity is thus achieved here. The calculation is based on the Bernoulli “free surface/free jet” equation simplified by Torricelli.

The pipe sections are preferably cast in the individual elements, preferably using concrete material (cement or polymer concrete), asphalt or plastic. This gives rise to monolithic concrete bodies, which give the individual elements a compact, easy-to-manipulate basic body while ensuring greater drainage capacity.

The pipe sections are preferably formed as plastic or metal pipe sections, as so-called “inliners”. It is also possible for the pipe section to consist of the casting material itself. In the production process, corresponding cores in the shape of the basic body are introduced, which form the pipe section after they are removed. This results in low flow resistance and thus high drainage capacity.

Preference is given to tip ends of the pipe sections protruding from the individual elements and to socket ends of the pipe sections being flush with the end faces of the individual elements. In this manner the individual elements can be sealingly secured adjacent to one another. On their end faces, the individual elements are preferably configured as concave and downwardly converging. In the event of assembly inaccuracies, the individual elements can thus be positioned closely next to one another, at least at their top edges. It is also possible to take vertical curvatures in the soil profile into account.

In addition to the pipe sections, which conduct liquid to be drained, preference is given to providing empty pipes in the individual elements for installing power lines or the like. Such empty pipes can also be used for supplying water for extinguishing fires or for flushing. At individual points, the empty pipes can be connected to the pipe sections via drain boxes, for example. In the event of a heavy flow (heavy rain or damage in a tunnel), for example, the excess liquid can thus be temporarily stored in the empty pipe. The drain box can be configured as a trap, e.g., sediment trap, light liquid trap, grease trap, or the like. In tunnel construction in particular, the drain box can be equipped with a downflow baffle to prevent fire from spreading through the drainage system in case a fire breaks out. It has been proven to be particularly advantageous if an empty pipe for heating devices, for example, is arranged in proximity to the drainage channel or the pipe sections. The geometry of the pipe sections and of the empty pipes can differ. The empty pipe or the pipe sections can consist of, for example, plastic, metal, concrete, or also ceramic material. The basic body in turn can consist of concrete, for example cement concrete but also polymer concrete or other concretes, as well as of metal or plastic.

The pipe sections preferably consist of standard commercially available drainage pipes having a lip end, a socket end, and an O-ring seal, and optionally of Y-pieces and Y-joints for interconnecting the pipe sections. Economical production is thus possible.

The inlet sections preferably comprise gutters having gutter drains, which are connected to the first pipe sections. These inlet sections in turn are preferably made of or reinforced with cast iron, thus giving rise to very economical yet stable individual elements.

Preferred embodiments of the invention are explained in more detail below with reference to figures, wherein:

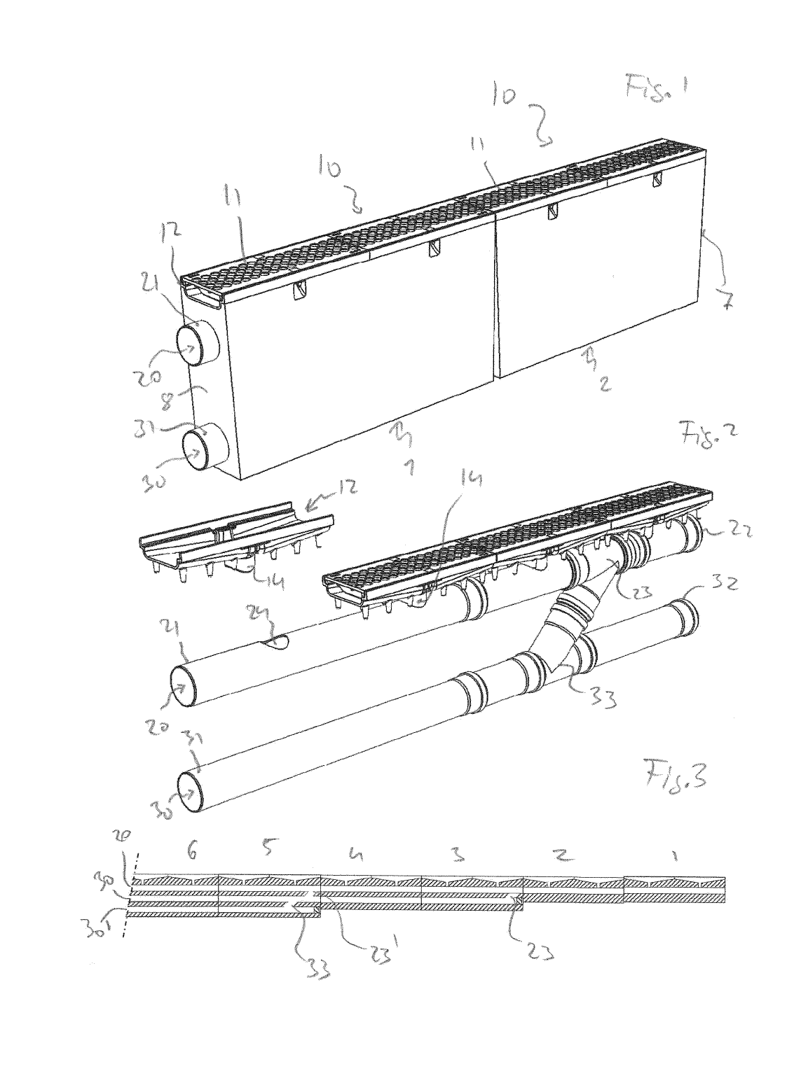

FIG. 1 shows a simple embodiment of the invention having two individual elements 1 and 2, which are coupled to one another,

FIG. 2 shows the arrangement according to FIG. 1, but with the cast material removed as well as with a gutter for forming an inlet section elevated, from which the drain grating has been taken off,

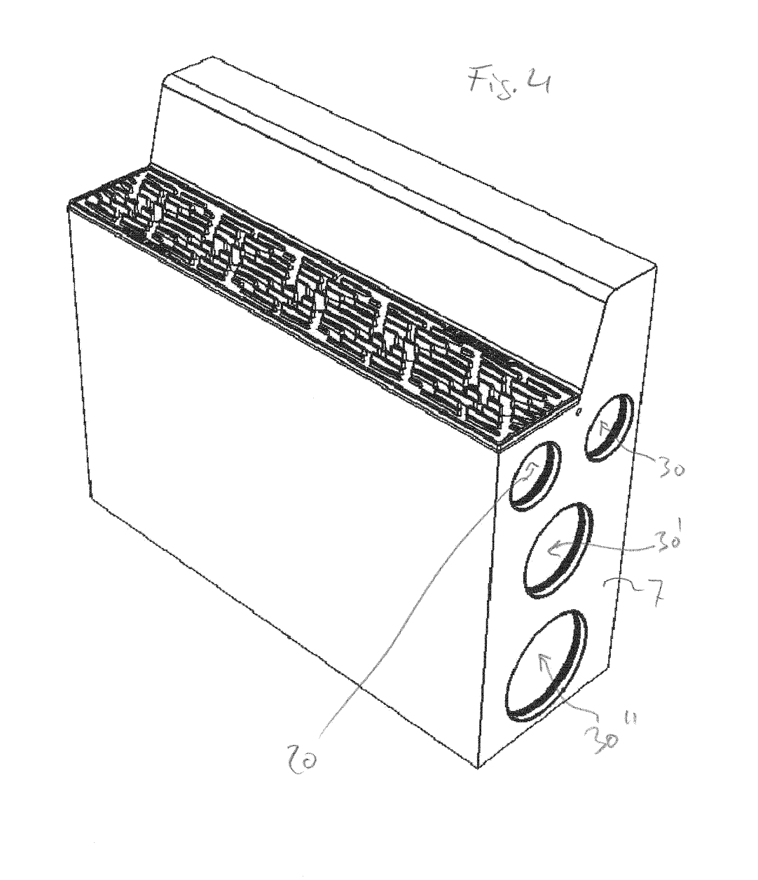

FIG. 3 is a schematic illustration of a channel run with individual elements placed next to one another,

FIG. 4 shows an embodiment of an individual element with a curb,

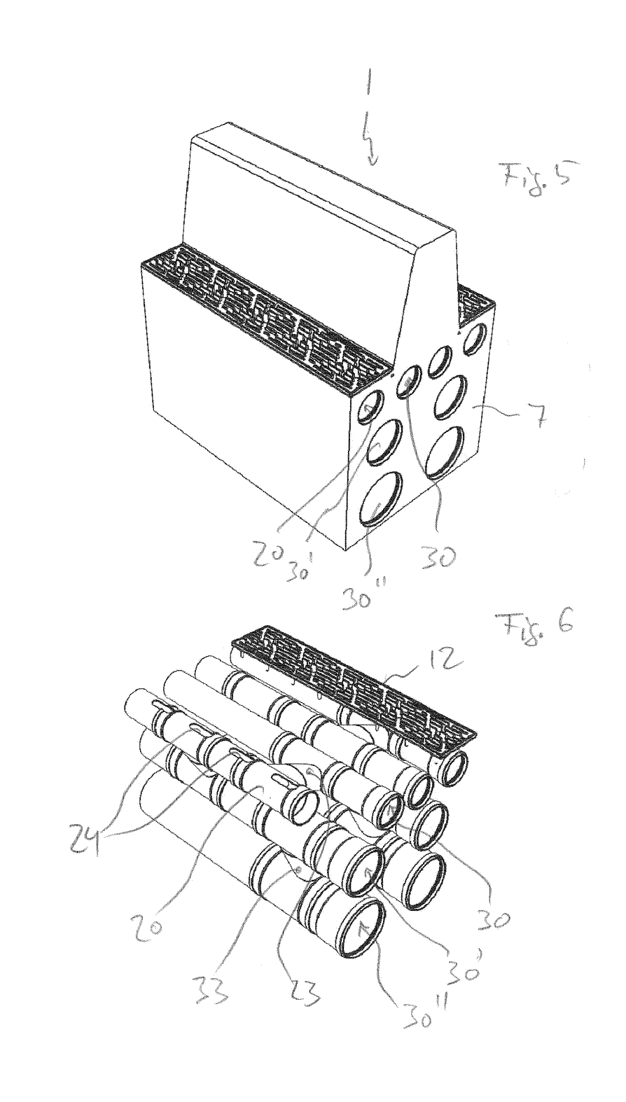

FIG. 5 shows an embodiment of an individual element for dividing two lanes from one another,

FIG. 6 is an illustration of the individual element according to FIG. 5, but without the casting material, and

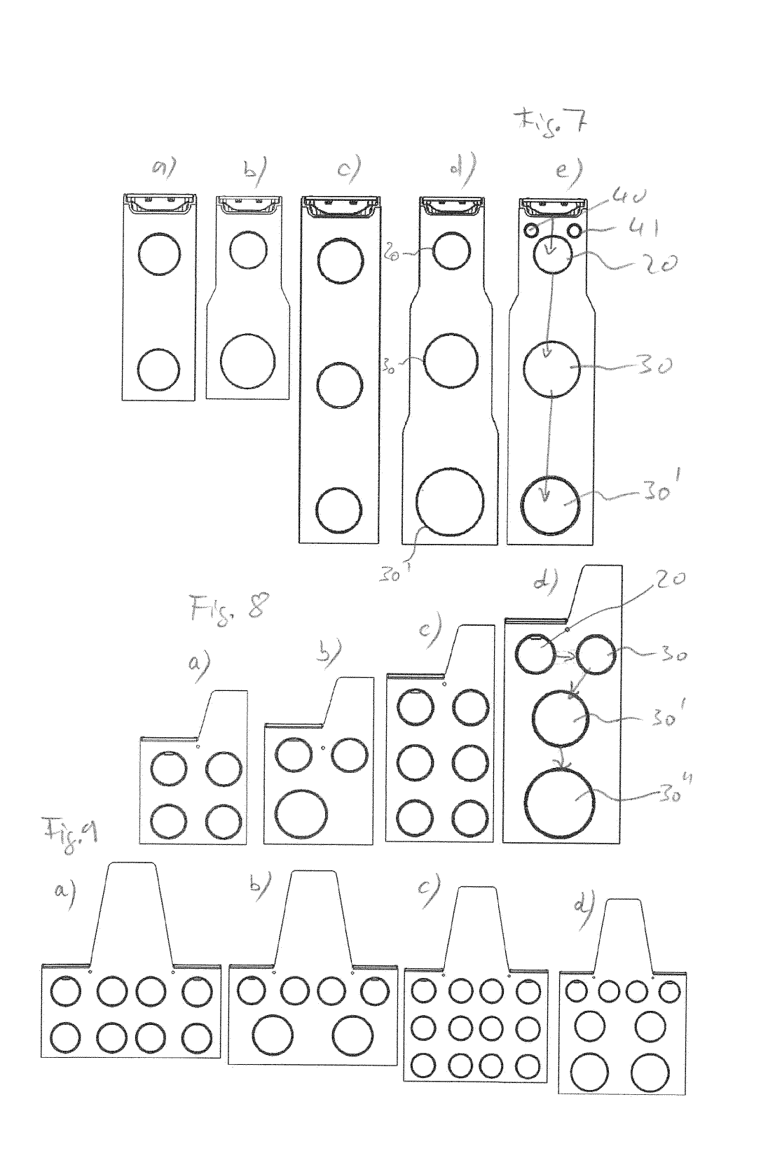

FIG. 7-9 show different embodiments of individual elements.

The same reference numbers are used for the same parts and parts with the same effect in the description below.

FIG. 1 shows two individual elements placed next to one another, each having, at their top edges, inlet sections 10 that are covered with gratings 11, below which lie gutters 12 made of cast iron. The gutters 12 are cast in the concrete bodies of the individual elements 1 and 2.

In addition, provision is made of upper pipe sections 20 and lower, second pipe sections 30, of which the tip ends 21 and 31, respectively, protrude from end walls 8. The end walls 7 of the individual elements 1 and 2 opposite the end walls 8 converge from the top down in such a way that even if the individual elements are relatively imprecisely set on their foundation, the top edges can be pushed together in tight abutment with each other. Furthermore, curvatures in a vertical direction (surface irregularities) are also possible.

The “inner workings” of the individual elements 1 and 2 from FIG. 1 are now shown in FIG. 2. Here it is evident that the gutters 12, on which the gratings 11 rest, have gutter drains 14 that lead to or are inserted in inlet openings 24 of the first, upper pipe section 20. The downward-projecting studs of the gutters 12 merely serve to anchor the latter more securely in the concrete body.

The pipe sections 20 and 30 of the front individual element 1 are not interconnected. However, the pipe sections 20 and 30 of the second individual element 2 are interconnected via Y-pieces 23 and 33 in such a way that water (coming from the right in FIGS. 1-3) flowing into the socket end 22 of the upper (right) pipe section 20 is at least partially shunted via the Y-pieces 23 and 33 into the lower pipe section 30.

FIG. 3 now shows how a channel run can be assembled.

One starts with individual elements 1 and 2, which only comprise an upper pipe section 20. If one now assumes a situation in which the upper pipe section 20 has already been filled by the water flowing into the two individual elements 1 and 2, then it would not be possible to take in any additional water in the case of a continuation of individual elements with just a single upper pipe section 20. However, an individual element in the third individual element 3 attaches to a lower pipe section 30, namely via a Y-piece 23, in the arrangement shown here. Thus “space is now created” in the upper pipe section 20 so that more water can be taken in. This continues by way of a third pipe section 30′, which is provided in the individual elements 5 and 6. Obviously this illustration is greatly simplified. In particular, a very high total drainage capacity is made possible by increasing the drainage capacity of the lower pipe sections 30 and 30′ so that many individual elements can take in surface water before an additional drainage aid by way of the other pipe sections becomes necessary.

In the embodiment of the invention shown in FIG. 4, a curb is integrated in the individual element.

Also deemed unique is the fact that the first pipe section 20. into which the inlet sections 10 drain, communicates with an essentially parallel second pipe section 30, from which underlying second pipe sections 30′, 30″ are then “supplied” with water. The lower pipe sections 30′, 30″ have larger cross sections. Advantageous geometric arrangements are thus achievable if the cross-sectional areas of the pipe sections increase in the individual elements from the top down.

In the embodiment of the invention shown in FIG. 5, two individual elements according to FIG. 4 are assembled back to back for dividing two lanes. It is readily evident that this gives rise to very compact components having enormously high drainage capacities. In this embodiment, the inlet section is configured as a one-piece ridge channel. This means that the gutter and the grating are of monolithic design. The “inner workings” of the lane divider with pipe sections at different heights and pipe sections with different diameters described in FIG. 5 are shown in FIG. 6. Furthermore, FIG. 6 shows that a plurality of pipe sections 20, 30 can also lie in a plane.

Different arrangements are now described in FIGS. 7-9, wherein reference shall be made expressly to the disclosure content of these arrangements. The operating principle is readily evident from the preceding descriptions.

Only the embodiment according to FIGS. 7d) and 7e) will be highlighted here, in which on one hand empty pipes 40 and 41 that are not used for water drainage are provided in the upper region. In addition, the cross sections of the pipe sections increase from the first pipe section 20 to the second pipe section 30 to the third pipe section 30′ (FIG. 7d). This increase in the cross sections of the pipe sections gives rise to a rather slim head of the individual elements 1 so that, in the case of correspondingly parallel lateral walls in the head region, the adjacent surface coverings (e.g., asphalt, pavement, concrete) can be easily worked to a specific height, optionally with an expansion joint, in typical fashion at the construction site.

From the above it follows that the invention relates not only to the individual elements, but also to a system that is assembled from different individual elements, in particular ones with an increasing number of pipe sections.

### LIST OF REFERENCE SIGNS

1-6 Individual element
7 End face
8 End face
10 Inlet section
11 Grating
12 Gutter
14 Gutter drain
20 First upper pipe section
21 Tip end
22 Socket end
23 Y-piece
24 Inlet opening
30 Second pipe section
31 Tip end
32 Socket end
33 Y -piece
40 Empty pipe
41 Empty pipe

1. A surface water drainage system comprising a drainage body, which is elongated by individual elements (1-6) that can be placed next to one another and which can be installed in the ground, wherein the individual elements comprise
an inlet section (10), which is arranged in an upper region of the individual elements (1-6) in such a way that water can flow into the inlet section (10),
at least one first upper pipe section (20) arranged below the inlet section (10) and communicating with the the inlet section (10) via transition systems (14, 24),
characterized in that
at least one further second pipe section (30) communicating with said first upper pipe section (20) is provided below or next to said first upper pipe section (20), wherein all of the pipe sections (20, 30) are connected to corresponding pipe sections (20, 30) of the individual elements (1-6).

2. The surface water drainage system according to claim 1, characterized in that
the pipe sections (20, 30) are cast in the individual elements (1-6) using concrete material, asphalt, or plastic.

3. The surface water drainage system according to claim 1, characterized in that
the pipe sections (20, 30) are plastic or metal pipe sections.

4. The surface water drainage system according to claim 1, characterized in that
tip ends (31) of the pipe sections (20-30) protrude from the individual elements (1-6) and socket ends (32) of the pipe sections (20, 30) end flush with end faces (7, 8) of the individual elements (1-6).

5. The surface water drainage system according to claim 4, characterized in that
the faces (7, 8) of the individual elements (1-6) are concave and downwardly converging.

6. The surface water drainage system according to claim 1, characterized in that
the individual elements (1-6) further comprise empty pipes (40, 41) for the installation of power lines.

7. The surface water drainage system according to claim 1, characterized in that
the pipe sections (20, 30) comprise drainage pipes comprising tip ends (21, 31), socket ends (22, 32), and O-ring seals, and optionally comprise Y-pieces (23, 33) and Y-joints.

8. The surface water drainage system according to claim 1, characterized in that
the inlet sections (10) comprise gutters (12) having gutter drains (14), which are connected to the first upper pipe sections (20).

9. The surface water drainage system according to claim 1, characterized in that
the inlet section (10) are made from or reinforced with cast iron.
